(19) United States
(12) Patent Application Publication
(10) Pub. No.: US 2026/0285727 A1
(43) Pub. Date: Sep. 24, 2026

(54) WASTEWATER TREATMENT SYSTEM AND METHOD OF TREATING WASTEWATER

(71) Applicant: PEGRAS ASIA PACIFIC PTY LTD, Macquarie Park, NSW (AU)

(72) Inventors: Stephanus Peters, Macquarie Park, NSW (AU); Ian Byrne, Macquarie Park, NSW (AU)

(73) Assignee: PEGRAS ASIA PACIFIC PTY LTD, Macquarie Park, NSW (AU)

(21) Appl. No.: 19/478,292

(22) PCT Filed: Apr. 24, 2024
(86) PCT No.: PCT/AU2024/050395

§ 371 Date: Oct. 24, 2025

(30) Foreign Application Priority Data
Apr. 26, 2023 (AU) 2023901236

(51) Int. Cl. C02F 9/00; C02F 1/32; C02F 1/38; C02F 1/50; C02F 1/52; C02F 1/68

(52) U.S. Cl. CPC C02F 9/00; C02F 1/325; C02F 1/385; C02F 1/50; C02F 1/5281; C02F 1/685

(57) ABSTRACT

A wastewater treatment system (10) including a dosing subsystem (12) wherein a coagulant is added to wastewater containing microparticles. The dosing subsystem (12) produces coagulant dosed wastewater comprising coagulated microparticles. The wastewater treatment system (10) further includes a mixing and dwell-time extension subsystem (14) in fluid communication with the dosing subsystem (12). The mixing and dwell-time extension subsystem (14) is adapted to receive the coagulant dosed wastewater and to cause microparticles of the coagulant dosed wastewater to agglomerate further to produce agglomerated microparticle wastewater. The wastewater treatment system (10) includes a separation subsystem (16) in fluid communication with the mixing and dwell-time extension subsystem (14). The separation subsystem (16) is adapted to receive the agglomerated microparticle wastewater and to separate agglomerated microparticles from the wastewater to produce separated microparticles and filtered wastewater.

### FIELD

The invention concerns a wastewater treatment system and a method of treating wastewater. In one non-exclusive aspect the invention concerns a wastewater treatment system and a method of treating wastewater to remove microparticles, such as microplastic particles, therefrom.

### BACKGROUND

Microparticles, also known as microspheres, refer to tiny particles that have a diameter in the micrometre range, typically from 0.1 to 100 micrometres (μm). They can be composed of various materials such as polymers, ceramics, metals, or composites and have diverse properties depending on their composition and intended use.

Key points about microparticles includes:
Manufacturing and Composition: Microparticles can be engineered from a wide range of materials including synthetic polymers (e.g., polystyrene, polymethylmethacrylate), natural polymers (e.g., gelatin, alginate), ceramics (e.g., silica), and metals. The choice of material depends on the application, considering factors such as biocompatibility, degradability, and mechanical strength.
Characteristics: The size, surface charge, and morphology (shape and surface texture) of microparticles can significantly influence their behaviour in different environments and applications. These characteristics can be finely tuned during their manufacturing process.
Applications: Microparticles have a broad range of applications across various fields:
   Medical and Pharmaceutical: In drug delivery systems, microparticles can be used to encapsulate drugs, protecting them from degradation and controlling their release over time. They are also used in diagnostics, tissue engineering, and as contrast agents in imaging.
   Cosmetics: Microparticles are used in cosmetic products for various purposes, including as carriers for active ingredients, in sunscreens, and as texturizing agents.
   Environmental: In environmental applications, microparticles can be used for water purification, pollution control, and as sensors for environmental monitoring.
   Food Industry: Microparticles can encapsulate flavours, vitamins, or probiotics to enhance food products' nutritional value, stability, and taste.
Environmental Concerns: Synthetic microparticles, particularly plastic microbeads used in personal care products, have raised environmental concerns due to their persistence in the environment and potential to harm aquatic life. This has led to regulatory efforts in many countries to limit their use.
Research and Development: The field of microparticles is continuously evolving, with research focusing on developing new materials, manufacturing techniques, and applications, including responsive systems that can change their properties in response to external stimuli.

Microparticles offer innovative solutions across a broad spectrum of applications, though they also present challenges that require careful consideration, particularly regarding their environmental impact.

Plastics come in various types, each possessing its own distinct characteristics and applications. Among them, polyethylene (PE) stands as a widely used plastic due to its chemical resistance and flexibility, making it ideal for packaging and household products. Polypropylene (PP), on the other hand, boasts durability and heat resistance, finding purpose in automotive parts and medical devices. Meanwhile, polyvinylchloride (PVC) exhibits versatility, making its way into construction materials, electrical cables, and even medical products.

In the realm of lightweight plastics, polystyrene (PS) takes the stage with its insulating properties, often employed in packaging and disposable utensils. Polyethylene terephthalate (PET), renowned for its transparency and moisture barrier, secures its place as the go-to plastic for beverage bottles and food containers. For unparalleled flexibility in applications, polyurethane (PU) showcases its adaptability in furniture, insulation, and even footwear.

The strong and transparent polycarbonate (PC) steps forward with its impact and heat resistance, finding purpose in eyeglass lenses, safety goggles, and automotive components. Acrylonitrile butadiene styrene (ABS), a tough and rigid plastic, thrives in consumer goods, automotive parts, and electronics with its notable impact resistance and surface finish.

Amid plastic's versatility, a pressing concern arises-microplastics. These tiny plastic particles, measuring less than 5 millimetres in size, encompass primary and secondary microplastics. Primary microplastics, such as microbeads and plastic pellets, are intentionally manufactured and used in products like personal care items and industrial processes. Secondary microplastics, on the other hand, result from the gradual degradation of larger plastic items in the environment.

Understanding the diverse array of plastics is crucial, not only for their functionality but also for the responsible management of their lifecycle. From the environmental concerns surrounding polyethylene microplastics to the recyclability of PET bottles, proper waste management and recycling practices play a pivotal role in curbing plastic pollution and fostering sustainability. By comprehending the characteristics and implications of different plastic types, and addressing the challenge of microplastics, it is possible to work towards a future that balances the benefits of plastics with a conscientious approach to their use and disposal.

Microplastics are small plastic particles that are less than 5 millimetres in size. They can be categorized into two main types: primary microplastics and secondary microplastics.
Primary Microplastics: These are manufactured as small plastic particles for specific purposes. They are intentionally produced and used in various products. Examples include microbeads found in personal care products like face scrubs and toothpaste, or plastic pellets used in industrial processes.
Secondary Microplastics: These are formed through the breakdown of larger plastic items or materials. Over time, larger plastic debris in the environment, such as plastic bags, bottles, and fishing nets, can degrade due to sunlight, wind, and waves, breaking down into smaller fragments. These fragments are considered secondary microplastics.

Microplastics come in a range of sizes, including:
Macroplastics: These are larger plastic items, such as bottles, bags, and packaging. They eventually break down into smaller pieces and become microplastics.
Mesoplastics: These are intermediate-sized plastic fragments that range from 5 millimetres to 1 millimetre in size.
Microplastics: These are tiny plastic particles that measure less than 1 millimetre in size. They can be further categorized into two subtypes:
   Primary Microplastics: These include microbeads and other small plastic particles intentionally produced for specific purposes, such as exfoliants in personal care products or as abrasive additives in cleaning products.
   Secondary Microplastics: These are the result of the degradation and fragmentation of larger plastic items in the environment.
Nanoplastics: These are even smaller particles, measuring less than 100 nanometres (0.1 micrometres) in size. Nanoplastics are of increasing concern due to their potential for easier ingestion by marine organisms and their ability to penetrate biological tissues.

The presence of microplastics in the environment, including freshwater systems, oceans, and even the air, has raised concerns due to their potential impact on ecosystems and human health. They can be ingested by a variety of organisms, accumulate in their tissues, and potentially move up the food chain. Research is ongoing to better understand the sources, distribution, and potential effects of microplastics on both environmental and human health.

A significant yet often overlooked source of microplastics is the laundry process. Clothes and other textiles made from synthetic fibres, such as polyester, nylon, and acrylic, release thousands of microplastic fibres every time they are washed. These microfibers are a form of secondary microplastics, which originate from the breakdown of larger plastic items in this case, synthetic textiles.

During a typical wash cycle, the agitation and friction cause tiny fibres to shed from the fabrics and escape with the wastewater. Due to their small size, these fibres can easily pass through water treatment facilities and end up in natural water bodies, such as rivers, lakes, and oceans. The environmental impact of these fibres is profound, as they add to the already significant burden of plastic pollution in aquatic ecosystems.

The textiles industry has been identified as a major contributor to microplastic pollution, with billions of synthetic fibres entering water systems globally every day. The implications of this are multi-faceted, affecting not only marine life but also the broader environmental and potentially human health, as these microplastics can enter the food chain.

Efforts to mitigate the release of microplastics from laundry include the development of washing machine filters designed to capture these fibres, the promotion of using washing bags that minimize fibre shedding, and the encouragement of choosing natural fibres over synthetic ones. Additionally, innovations in textile manufacturing aim to reduce the shedding of fibres at the source.

Understanding and addressing the issue of microplastics in laundry is an essential step towards reducing the overall release of microplastics into the environment. It highlights the need for individual actions, such as changing laundry habits and making informed choices about clothing, as well as broader systemic changes in manufacturing and waste management practices, to tackle the complex challenge of plastic pollution.

Various methods have been proposed to remove microplastics from wastewater. Such methods include physical, chemical and biological treatment. Physical treatment methods such as filtration and sedimentation are typically employed for removing relatively large plastic particles. Physical treatment methods suffer from the drawback of being ineffective for removing microplastic particles of smaller dimension. Chemical and biological treatment methods have accordingly been developed with a view of removing smaller sized microplastic particles. Chemical and biological treatment methods, however, suffer from the drawback that they require complex treatment systems. Such treatment systems are expensive to produce and run.

### OBJECT

It is an object of the invention to provide a wastewater treatment system and a method of treating wastewater which address the above problems associated with conventional wastewater treatment systems, or at least to provide a useful alternative system and method of treating wastewater to remove microparticles such as microplastic particles therefrom.

### SUMMARY

According to a first aspect there is disclosed herein a wastewater treatment system including:
a dosing subsystem wherein a coagulant is added to wastewater containing microparticles, the dosing subsystem producing coagulant dosed wastewater comprising coagulated microparticles;
a mixing and dwell-time extension subsystem in fluid communication with the dosing subsystem, the mixing and dwell-time extension subsystem adapted to receive the coagulant dosed wastewater and to cause microparticles of the coagulant dosed wastewater to agglomerate further to produce agglomerated microparticle wastewater; and
a separation subsystem in fluid communication with the mixing and dwell-time extension subsystem, the separation subsystem adapted to receive the agglomerated microparticle wastewater and to separate agglomerated microparticle particles from the wastewater to produce separated microparticles and filtered wastewater.

Preferably the wastewater treatment system includes a collection subsystem associated with the separation subsystem, the collection subsystem adapted to separately accumulate the separated agglomerated microparticles and the filtered wastewater produced by the separation subsystem.

Preferably the dosing subsystem includes a coagulant dosing unit, the coagulant dosing unit having a wastewater inlet adapted to receive wastewater from a wastewater supply and a coagulant inlet adapted to add coagulant from a supply of coagulant to the wastewater within the coagulant dosing unit.

Preferably the mixing and dwell-time extension subsystem includes a static mixer adapted to mix the coagulant dosed wastewater.

Preferably the mixing and dwell-time extension subsystem includes a pipe network adapted to facilitate mixing of the coagulant dosed wastewater.

Preferably the separation subsystem includes a centrifugal density separation assembly.

Preferably the centrifugal density separation assembly includes a high-speed disc stack centrifugal separation assembly.

Preferably the wastewater treatment system includes a disinfectant subsystem.

Preferably the disinfectant subsystem includes an ultraviolet light adapted to kill bacteria.

According to a second aspect there is disclosed herein a method of treating wastewater, the method including the steps of:
providing a supply of wastewater containing microparticles;
dosing the wastewater containing microparticles with a coagulant to produce coagulant dosed wastewater;
feeding the coagulant dosed wastewater to a mixing and dwell-time extension subsystem;
causing the microparticles of the coagulant dosed wastewater to agglomerate to form agglomerated microparticles to produce agglomerated microparticle wastewater;
feeding the agglomerated microparticle wastewater to a separation subsystem; and
separating the agglomerated microparticles from the wastewater to produce filtered wastewater which has been separated from the agglomerated microparticles.

Preferably the method of treating wastewater includes the step of separately collecting the agglomerated microparticles and the filtered wastewater resulting from the separating step.

### BRIEF DESCRIPTION OF THE DRAWINGS

Preferred embodiments of the invention will be described hereinafter, by way of examples only, with reference to the accompany drawings.

In the drawings:

FIG. 1 is a diagrammatic representation of a first embodiment wastewater treatment system for use in removing microparticles from wastewater;

FIG. 2 is a diagrammatic representation of a first embodiment method of treating wastewater for removing microparticles from wastewater; and

FIG. 3 is a diagrammatic representation of a second embodiment wastewater treatment system for use in removing microparticles from wastewater.

### DESCRIPTION OF PREFERRED EMBODIMENTS

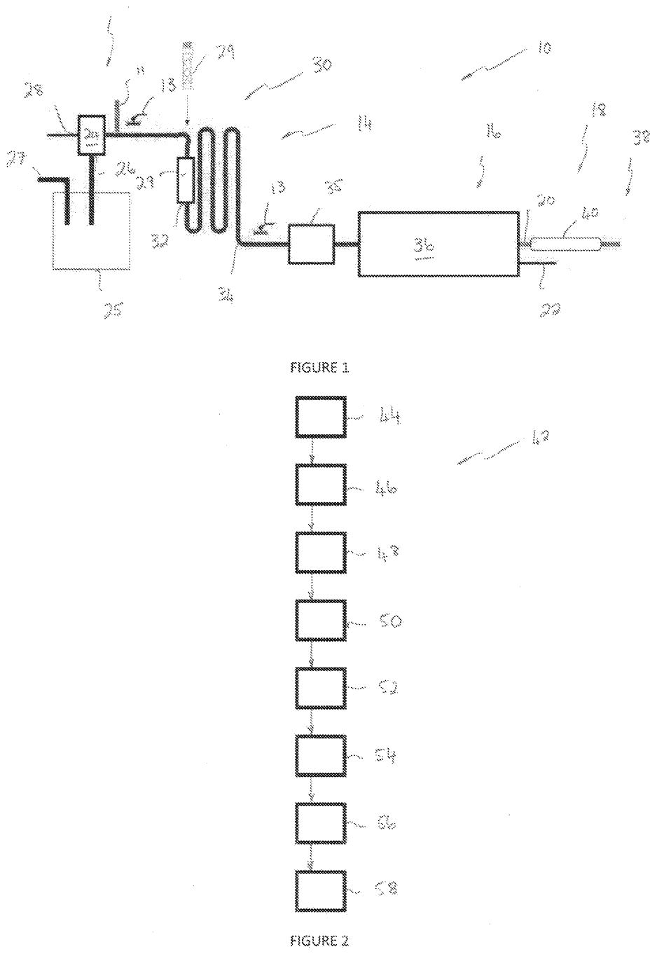

FIG. 1 provides a diagrammatic representation of a first embodiment wastewater treatment system, generally indicated with the reference numeral 10, specifically a wastewater treatment system to treat laundry wastewater to remove microparticles such as microplastic particles. The wastewater treatment system 10 includes a dosing subsystem 12. In the dosing subsystem 12 a coagulant is added to wastewater containing microparticles. Following dosing with a coagulant the dosing subsystem 12 produces coagulant dosed wastewater comprising coagulated microparticles.

The wastewater treatment system 10 includes a mixing and dwell-time extension subsystem 14 which is in fluid communication with the dosing subsystem 12. The mixing and dwell-time extension subsystem 14 is adapted to receive the coagulant dosed wastewater produced by the dosing subsystem 12 and to cause microparticles of the coagulant dosed wastewater to agglomerate further to produce agglomerated microparticle wastewater.

The wastewater treatment system 10 further includes a separation subsystem 16 which is in fluid communication with the mixing and dwell-time extension subsystem 14. The separation subsystem 16 is adapted to receive the agglomerated microparticle wastewater from the mixing and dwell-time extension subsystem 14 and to separate agglomerated microparticles from the wastewater to produce separated microparticles and filtered wastewater.

A collection subsystem 18 is provided which is associated with the separation subsystem 16. The collection subsystem 18 is adapted to separately accumulate the separated agglomerated microparticles and the filtered wastewater produced by the separation subsystem 16. FIG. 1 shows a filtered wastewater line 20 and a microparticles line 22 respectively for transporting filtered wastewater and separated microparticles.

The dosing subsystem 12 includes a coagulant dosing unit 24 having (i) a wastewater inlet 26 adapted to receive wastewater from an intermediate wastewater supply tank 25, and (ii) a coagulant inlet 28 adapted to add coagulant from a non-illustrated supply of coagulant to the wastewater within the coagulant dosing unit 24. The coagulant dosing unit 24 injects coagulant into the wastewater in a proportional volume to the wastewater (typically in a range of 0.01% to 0.1%). The coagulant agglomerates the microparticles into larger particles sizes, which includes suspended solids, thereby enhancing the flocculation and enhance removability.

In this embodiment the intermediate wastewater supply tank 25 includes a wastewater supply inlet 27 which feeds wastewater from a laundry tank or coarse filter system tank to the intermediate wastewater supply tank 25.

The coagulant can take the form of different substances which are suitable for promoting the agglomeration of microparticles. Examples of coagulants which could be used include cationic polymers and surfactants. It will be noted that the dosing subsystem 12 is located upstream of the separation subsystem 16. It is pointed out that the rate of injecting coagulant into the wastewater should preferably be set to optimise agglomeration. Such action will assist in removing the maximum amount of microparticles and suspended solids from the wastewater.

The mixing and dwell-time extension subsystem 14 includes a static mixer 29, such as a PVC or steel static mixer, adapted to mix the coagulant dosed wastewater supplied by the dosing subsystem 12. The mixing and dwell-time extension subsystem 14 further includes a pipe network 30 adapted to facilitate mixing of the coagulant dosed wastewater. The mixer 29 is in fluid communication with the pipe network 30. The process of continuous mixing of the coagulant dosed wastewater in the pipe network 30 involves several stages. Specifically, the coagulant dosed wastewater is introduced to the pipe network 30 via a pipe inlet 32. The coagulant dosed wastewater will flow through the pipe network 30 due to a pressure differential between the pipe inlet 32 and a pipe outlet 34. As the coagulant dosed wastewater flows through the pipe network 30 it will encounter various obstacles and changes in direction which will promote turbulent flow in the coagulant dosed wastewater. Such turbulence will cause the coagulant dosed wastewater to mix with itself. If other additives or liquids have been introduced to the wastewater, the turbulence will also promote mixing of such additives or other liquids. Continued mixing of the coagulant dosed wastewater will promote homogenisation until the agglomerated microparticle wastewater exits the pipe network 30 via the pipe outlet 34 and is introduced to the separation subsystem 16 via feed pump 35.

The degree of mixing achieved in the pipe network 30 is a function of various factors. Those factors include flow rate of the coagulant dosed wastewater, the viscosity of the coagulant dosed wastewater, the diameter of piping in the pipe network 30, turbulence created in the coagulant dosed wastewater and the presence of obstacles or mixing elements such as baffles or mixers. It is envisaged that to optimise mixing of the coagulant dosed wastewater mathematical models and flow simulators may be employed to predict flow patterns and to design an efficient pipe network 30.

The pipe network 30 further is used to extend the turbulent mixing time or dwell time, meaning the time the coagulant dosed wastewater remains within the pipe network 30. In general, when wastewater flows through a pipe, turbulence is created due to the friction between the water and walls of the pipe. Such turbulence causes water to mix and blend with any particles present within the water. If those particles are denser than water, they will tend to settle towards the bottom of the pipe under the influence of gravity. However, if the turbulent flow is of sufficient intensity, the mixing and blending of water will be strong enough to maintain particles suspended in the water, preventing the particles from settling. The degree of suspension is a function of the size and density of the particles, flow velocity and turbulence intensity. In low concentration scenarios, there may be brief periods during which an amount of particles may settle towards the bottom of the pipe. However, as flow continues, such particles will be mixed back into the water by turbulent flow.

In some applications, additional mixing elements may be added to the pipe network 30 to improve mixing during the dwell time. Such mixing elements may include non-illustrated static mixers or mixing baffles.

The separation subsystem 16 includes a high-speed disc stack centrifugal separation unit 36 adapted to separate the agglomerated microparticle wastewater produced by the mixing and dwell-time extension subsystem 14 to separate the microparticles (having a relatively high density) from the water phase. Specifically, the centrifugal separation unit 36 includes a non-illustrated rapidly spinning container. Such rapidly spinning container will generate a centrifugal force which will cause the denser microparticles to move away from the centre of the container while the less dense water phase will remain closer to the centre of the container.

The collection subsystem 18 may include a non-illustrated storage tank or, as is here the case, a discharge pipe provided in the form of the filtered wastewater line 20. The collection subsystem 18 may be in fluid communication with a further treatment subsystem. In this embodiment the wastewater treatment system 10 includes a further treatment system in the form of a disinfectant subsystem 38 through which the filtered wastewater is caused to pass. The disinfectant subsystem 38 includes an ultraviolet light 40 adapted to kill bacteria present in the filtered wastewater.

The embodiment wastewater treatment system 10 includes a freshwater inlet 11 located downstream of the coagulant dosing system 12 as well as cooperating valves 13 to facilitate flushing for cleaning the wastewater treatment system 10.

FIG. 2 provides a diagrammatic representation of a first embodiment method of treating wastewater, generally indicated with the reference numeral 42. The method of treating wastewater 42 includes the step 44 of providing a supply of wastewater containing microparticles and then the step 46 of dosing the wastewater containing microparticles with a coagulant to produce coagulant dosed wastewater. Hereafter the method of treating wastewater 42 includes the step 48 of feeding the coagulant dosed wastewater to a mixing and dwell-time extension subsystem and then the step 50 of causing the microparticles of the coagulant dosed wastewater to agglomerate to form agglomerated microparticles suspended in the agglomerated microparticle wastewater. Hereafter the method of treating wastewater 42 includes the step 52 of feeding the agglomerated microparticle wastewater to a separation subsystem and then the step 54 of separating the agglomerated microparticles from the wastewater to produce filtered wastewater which has been separated from the agglomerated microparticles.

The embodiment method of treating wastewater 42 includes the step 56 of separately collecting the agglomerated microparticles and the filtered wastewater resulting from the separating step 54. The embodiment method of treating wastewater 42 finally includes the step 58 of disinfecting the filtered wastewater.

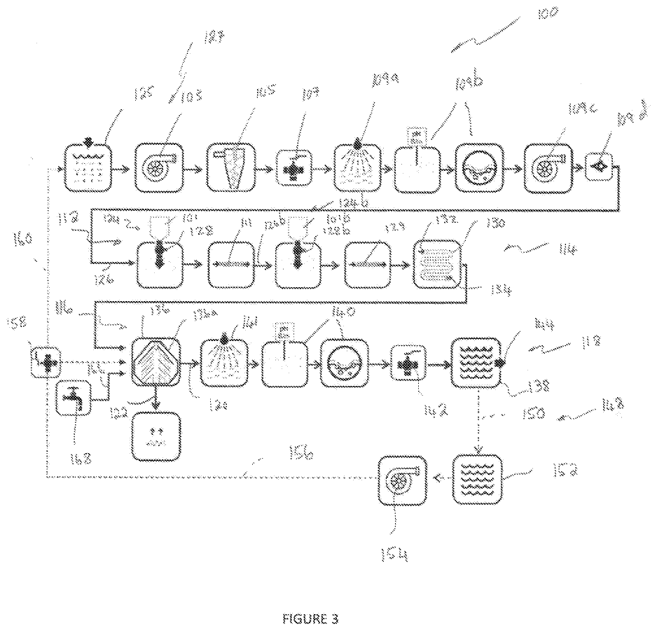

FIG. 3 provides a diagrammatic representation of a second embodiment wastewater treatment system, generally indicated with the reference numeral 100, specifically a wastewater treatment system for treating laundry water. It will of course be appreciated that the disclosed wastewater treatment system is not limited to treating laundry water, but has a broad application for removing microparticles from wastewater. The wastewater treatment system 100 includes a dosing subsystem 112. In the dosing subsystem 112 coagulant is added to wastewater containing microparticles. Following dosing with coagulant the dosing subsystem 112 produces coagulant dosed wastewater comprising coagulated microparticles.

The wastewater treatment system 100 includes a mixing and dwell-time extension subsystem 114 which is in fluid communication with the dosing subsystem 112. The mixing and dwell-time extension subsystem 114 is adapted to receive the coagulant dosed wastewater produced by the dosing subsystem 112 and to cause microparticles of the coagulant dosed wastewater to agglomerate further to produce agglomerated microparticle wastewater.

The wastewater treatment system 100 further includes a separation subsystem 116 which is in fluid communication with the mixing and dwell-time extension subsystem 114. The separation subsystem 116 is adapted to receive the agglomerated microparticle wastewater from the mixing and dwell-time extension subsystem 114 and to separate agglomerated microparticles from the wastewater to produce separated microparticles and filtered wastewater.

A collection subsystem 118 is provided which is associated with the separation subsystem 116. The collection subsystem 118 is adapted to separately accumulate the separated agglomerated microparticles and the filtered wastewater produced by the separation subsystem 116. A filtered wastewater line 120 and a microparticles line 122 respectively for transporting filtered wastewater and separated microparticles are provided in the wastewater treatment system 100. The microparticles line 122 may include a non-illustrated solid removals unit for removing solids from filtered water. The filtered water is drained and fed to a non-illustrated site waste.

The dosing subsystem 112 includes a first coagulant dosing unit 124 having (i) a wastewater inlet 126 adapted to receive wastewater from a wastewater supply tank 125 storing waste laundry water, and (ii) a coagulant inlet 128 adapted to add coagulant from a supply of coagulant, stored in a replaceable coagulant container 101 to the wastewater within the first coagulant dosing unit 124. The first coagulant dosing unit 124 injects coagulant into the wastewater in a proportional volume to the wastewater (typically in a range of 0.01% to 0.1%). The coagulant agglomerates the microparticles into larger particles sizes, which includes suspended solids, thereby enhancing the flocculation and enhanced removability.

In this embodiment the wastewater inlet 126 is in fluid communication with the wastewater supply tank 125 via a wastewater supply line 127 which includes a feed pump 103 feeding wastewater to a wastewater separation system 105. The wastewater separation system 105 is typically provided in the form of a strainer or a cyclone separator or decanter system adapted to remove particles larger than 0.5 mm. From the wastewater separation system 105 wastewater passes through a three-way valve 107 towards the wastewater inlet 126 of the first coagulant dosing unit 124. An optional ultraviolet sterilisation unit 109a is located between the three-way valve 107 and the wastewater inlet 126 to eliminate bacteria within the wastewater. Located between the ultraviolet sterilisation unit 109a and the wastewater inlet 126 there are also provided pH, conductivity and turbidity measurement system 109b as well as pump 109c and a valve 109d.

The dosing subsystem 112 includes a second coagulant dosing unit 124b having (i) a coagulant dosed wastewater inlet 126b adapted to receive wastewater from the first coagulant dosing unit 124, and (ii) a coagulant inlet 128b adapted to add coagulant from a supply of coagulant, stored in a replaceable coagulant container 101b to the coagulant dosed wastewater within the second coagulant dosing unit 124b. It is pointed out that a static mixing system 111 is located between the first and second coagulant dosing units 124, 124b.

The mixing and dwell-time extension subsystem 114 includes a static mixer 129, here a steel static mixer, adapted to mix the coagulant dosed wastewater supplied by the dosing subsystem 112. The mixing and dwell-time extension subsystem 114 further includes a pipe network 130 adapted to facilitate mixing of the coagulant dosed wastewater. The static mixer 129 is in fluid communication with the pipe network 130. The process of continuous mixing of the coagulant dosed wastewater in the pipe network 130 involves several stages. Specifically, the coagulant dosed wastewater is introduced into the pipe network 130 via a pipe inlet 132. The coagulant dosed wastewater will flow through the pipe network 130 due to a pressure differential between the pipe inlet 132 and a pipe outlet 134. As the coagulant dosed wastewater flows through the pipe network 130 it will encounter various obstacles and changes in direction which will promote turbulent flow in the coagulant dosed wastewater. Such turbulence will cause the coagulant dosed wastewater to mix with itself. If other additives or liquids have been introduced to the wastewater, the turbulence will also promote mixing of such additives or other liquids. Continued mixing of the coagulant dosed wastewater will promote homogenisation until the agglomerated microparticle wastewater exits the pipe network 130 via the pipe outlet 134 and is introduced to the separation subsystem 116.

The separation subsystem 116 includes a high-speed disc stack centrifugal separation unit 136 adapted to separate the agglomerated microparticle wastewater produced by the mixing and dwell-time extension subsystem 114 so as to separate the microparticles (having a relatively high density) from the water phase. Specifically, the separation unit 136 includes a rapidly spinning container 136a. Such rapidly spinning container 136a will generate a centrifugal force which will cause the denser microparticles to move away from the centre of the container while the less dense water phase will remain closer to the centre of the container. The disc stack separation unit 136 is adapted to remove fine particles smaller than 05 mm.

The collection subsystem 118 includes a clean water storage tank 138. The clean water storage tank 138 is in fluid communication with a pH, conductivity and turbidity measurement system 140. A manual flushing valve 142 is located in-line between the pH, conductivity and turbidity measurement system 140 on the one side and the clean water storage tank 138 on the other. The pH, conductivity and turbidity measurement system 140 cooperates with a non-illustrated controller to control dosing activity of the dosing subsystem 112. An ultraviolet (UV) sterilisation unit 141 is located in-line between the disc stack separation unit 136 and the pH, conductivity and turbidity measurement system 140.

The clean water storage tank 138 includes a clean water storage tank outlet 144 to supply filtered wastewater for use in, for example, a laundry. It is pointed out that a non-illustrated ultraviolet sterilisation unit may be located in position between the clean water storage outlet 144 and a point of use.

The second embodiment wastewater treatment system 100 includes a recycle subsystem 148. The recycle subsystem includes a recycle line 150 which is in fluid communication with a recycle tank 152. A recycle pump 154 is in fluid communication with the separation unit 136 via a separation unit line 156. The separation unit line 156 further includes a three-way valve 158 to provide fluid communication between the separation unit line 156 and a wastewater tank line 160 such that water from the clean water storage tank 138 can be returned to the wastewater supply tank 125. Water to the separation unit line 156 can be employed to clean the separation subsystem 116.

The separation subsystem 116 includes a water supply line 166 to supply operating water from a mains water supply 16.

Although the invention has been described with reference to specific examples, it will be appreciated by those skilled in the art that the invention may be embodied in many other forms.

### KEY TO REFERENCE NUMERALS IN DRAWINGS

10 First embodiment wastewater treatment system
11 Fresh water inlet
12 Dosing subsystem
13 Valve
14 Mixing and dwell-time extension subsystem
16 Separation subsystem
18 Collection subsystem
20 Filtered wastewater line
22 Microparticles line
24 Coagulant dosing unit
25 Intermediate wastewater supply tank
26 Wastewater inlet
27 Wastewater supply inlet
28 Coagulant inlet
29 Static mixer
30 Pipe network
32 Pipe inlet
34 Pipe outlet
35 Feed pump
36 Centrifugal separation unit
38 Disinfectant subsystem
40 Ultraviolet let
42 First embodiment method of treating wastewater
44 Providing a supply of wastewater
46 Dosing step
48 Feeding step
50 Agglomeration step
52 Feeding step
54 Separating step
56 Collecting step
58 Disinfecting step
100 Second embodiment wastewater treatment system
101 Coagulant container
101b Coagulant container
103 Feed pump
105 Wastewater separation system
107 Three-way valve
109a Ultraviolet (UV) sterilisation unit
109b pH, conductivity and turbidity measurement system
109c Pump
109c Pressure valve
111 Static mixing system
112 Dosing subsystem
114 Mixing and dwell-time extension subsystem
116 Separation subsystem
118 Collection subsystem
120 Filtered wastewater line
122 Microparticles line
124 First coagulant dosing unit
124b Second coagulant dosing unit
125 Wastewater supply tank
126 Wastewater inlet
126b Wastewater inlet
127 Wastewater supply line
128 Coagulant inlet
128b Coagulant inlet
129 Static mixer
130 Pipe network
132 Pipe inlet
134 Pipe outlet
136 Separation unit
136a Spinning container
138 Clean water storage tank
140 pH, conductivity and turbidity measurement system
141 Ultraviolet (UV) sterilisation unit
142 Flushing valve
144 Clean water storage tank outlet
148 Recycle subsystem
150 Recycle line
152 Recycle tank
154 Recycle pump
156 Separation unit line
158 Three-way valve
160 Wastewater tank line
166 Water supply line
168 Mains water supply

1. A wastewater treatment system including:
a dosing subsystem wherein a coagulant is added to wastewater containing microparticles, the dosing subsystem producing coagulant dosed wastewater comprising coagulated microparticles;
a mixing and dwell-time extension subsystem in fluid communication with the dosing subsystem, the mixing and dwell-time extension subsystem adapted to receive the coagulant dosed wastewater and to cause microparticles of the coagulant dosed wastewater to agglomerate further to produce agglomerated microparticle wastewater; and
a separation subsystem in fluid communication with the mixing and dwell-time extension subsystem, the separation subsystem adapted to receive the agglomerated microparticle wastewater and to separate agglomerated microparticles from the wastewater to produce separated microparticles and filtered wastewater.

2. A wastewater treatment system according to claim 1, including a collection subsystem associated with the separation subsystem, the collection subsystem adapted to separately accumulate the separated agglomerated microparticles and the filtered wastewater produced by the separation subsystem.

3. A wastewater treatment system according to claim 2, wherein the dosing subsystem includes a coagulant dosing unit, the coagulant dosing unit having a wastewater inlet adapted to receive wastewater from a wastewater supply and a coagulant inlet adapted to add coagulant from a supply of coagulant to the wastewater within the coagulant dosing unit.

4. A wastewater treatment system according to claim 3, wherein the mixing and dwell-time extension subsystem includes a static mixer adapted to mix the coagulant dosed wastewater.

5. A wastewater treatment system according to claim 4, wherein the mixing and dwell-time extension subsystem includes a pipe network adapted to facilitate mixing of the coagulant dosed wastewater.

6. A wastewater treatment system according to claim 5, wherein the separation subsystem includes a centrifugal density separation assembly.

7. A wastewater treatment system according to claim 6, wherein the centrifugal density separation assembly includes a high-speed disc stack centrifugal separation assembly.

8. A wastewater treatment system according to claim 7 including a disinfectant subsystem.

9. A wastewater treatment system according to claim 8, wherein the disinfectant subsystem includes an ultraviolet light adapted to kill bacteria.

10. A method of treating wastewater, the method including the steps of:
providing a supply of wastewater containing microparticles;
dosing the wastewater containing microparticles with a coagulant to produce coagulant dosed wastewater;
feeding the coagulant dosed wastewater to a mixing and dwell-time extension subsystem;
causing the microparticles of the coagulant dosed wastewater to agglomerate to form agglomerated microparticles to produce agglomerated microparticle wastewater;
feeding the agglomerated microparticle wastewater to a separation subsystem; and
separating the agglomerated microparticles from the wastewater to produce filtered wastewater which has been separated from the agglomerated microparticles.

11. A method of treating wastewater according to claim 10, including the step of separately collecting the agglomerated microparticles and the filtered wastewater resulting from the separating step.

12. A wastewater treatment system according to claim 1, wherein the dosing subsystem includes a coagulant dosing unit, the coagulant dosing unit having a wastewater inlet adapted to receive wastewater from a wastewater supply and a coagulant inlet adapted to add coagulant from a supply of coagulant to the wastewater within the coagulant dosing unit.

13. A wastewater treatment system according to claim 1, wherein the mixing and dwell-time extension subsystem includes a static mixer adapted to mix the coagulant dosed wastewater.

14. A wastewater treatment system according to claim 2, wherein the mixing and dwell-time extension subsystem includes a static mixer adapted to mix the coagulant dosed wastewater.

15. A wastewater treatment system according to claim 13, wherein the mixing and dwell-time extension subsystem includes a pipe network adapted to facilitate mixing of the coagulant dosed wastewater.

16. A wastewater treatment system according to claim 14, wherein the mixing and dwell-time extension subsystem includes a pipe network adapted to facilitate mixing of the coagulant dosed wastewater.

17. A wastewater treatment system according to claim 13, wherein the separation subsystem includes a centrifugal density separation assembly.

18. A wastewater treatment system according to claim 14, wherein the separation subsystem includes a centrifugal density separation assembly.

19. A wastewater treatment system according to claim 15, wherein the separation subsystem includes a centrifugal density separation assembly.

20. A wastewater treatment system according to claim 16, wherein the separation subsystem includes a centrifugal density separation assembly.
